(19) United States
(12) Patent Application Publication
(10) Pub. No.: US 2002/0073057 A1
(43) Pub. Date: Jun. 13, 2002

(54) Software distribution system and method

(76) Inventors: Darlene Benoit, Elverson, PA (US); Kenneth Cooper, Philadelphia, PA (US); Peter Howe, Downingtown, PA (US); Jane Laky, Schwenksville, PA (US); Brian Jarvis, Spring City, PA (US)

Correspondence Address: VENABLE, BAETJER, HOWARD & CIVILETTI, LLP, P.O. Box 34385, Washington, DC, 20043-9998, US

(21) Appl. No.: 09/732,896

(22) Filed: Dec. 11, 2000

(51) Int. Cl. G06F 7/00

(52) U.S. Cl. 707/1

(57) ABSTRACT

A Web-based system and method for selectively reproducing software files for distribution to a user, to support that user's already authorized and installed software applications includes a web server, a database containing a selection of software files, a graphical user interface (GUI) for accessing the database remotely by an authorized subscriber of one or more subsets of the software files, a GUI for searching the database to determine what, if any, additional software files are available to the authorized subscriber, a GUI for displaying the results of such search, a GUI for selecting software files to be reproduced and delivered to the authorized subscriber, means for reproducing such selected software in a computer readable medium, and means for coordinating the shipment of that computer readable medium to the authorized subscriber for the purposes of updating, upgrading, and installing new revisions of the software applications of a client device operated by such authorized subscriber.

### CROSS-REFERENCE TO RELATED APPLICATIONS

This patent application is related to the following co-pending patent applications: (a) U.S. Ser. No. 09/296,738, filed Apr. 22, 1999, entitled “System for Collaborative Engineering Using Component and File-Oriented Tools”; and (b) U.S. Ser. No. 09/586,784, filed Jun. 5, 2000, entitled “System and Method of Providing Engineering, Construction, and Operations Computer-Aided Design Services, both of which are commonly assigned to the assignee of the present invention and is incorporated herein by reference.

### BACKGROUND OF THE INVENTION

1. Field of the Invention

The present invention relates generally to systems and methods of software distribution, and more particularly to a Web-based system and method for selectively reproducing software files for distribution to a user, to support that user's already authorized and installed software applications.

2. Statement of the Prior Art

User defined assembly and manufacture of a product, especially computer readable media, wherein each component of the manufacturing process and system can be remotely located to decentralize the manufacturing process, is known in the prior art. For example, U.S. Pat. No. 5,930,768 (Hooban) is directed to the popular use of an Internet (i.e., a TCP/IP compliant) graphical user interface (GUI), which allows the user to interactively query a repository of song titles and artists and select, delete, and reorder a desired compilation of songs. Other examples of similar such customized audio CD reproduction systems and methods are disclosed in U.S. Pat. Nos. 5,959,944, 5,974,004, and 6,011,758 (Dockes et al.). However, none of the above-referenced patents are directed to Web-based systems and methods for selectively reproducing software files for distribution to a user, in order to support that user's already authorized and installed software applications.

Other forms of software support, particularly software updates, upgrades, and new revisions, which are accessible over the Internet by users, are available only for download or much later delivery of standard computer-readable media which is subject to inventory and back orders. It would be desirable to provide a Web-based system and method for selectively reproducing software files for distribution to a user, to support that user's already authorized and installed software applications, which avoids the problems of downloading and back-ordered inventory.

### SUMMARY OF THE INVENTION

The present invention, comprising a web server, a database containing a selection of software files, graphical user interface (GUI) means for accessing the database remotely by an authorized subscriber of one or more subsets of the software files, GUI means for searching the database to determine what, if any, additional software files are available to the authorized subscriber, GUI means for displaying the results of such search, GUI means for selecting software files to be reproduced and delivered to the authorized subscriber, means for reproducing such selected software in a computer readable medium, and means for coordinating the shipment of that computer readable medium to the authorized subscriber for the purposes of updating, upgrading, and installing new revisions of the software applications of a client device operated by such authorized subscriber.

The foregoing and other objects, advantages, and novel features according to the present invention shall become more apparent from the following detailed description of the invention, when considered in conjunction with the accompanying drawings wherein:

### BRIEF DESCRIPTION OF THE DRAWINGS

FIG. 1 is a simplified block diagram of the software distribution system according to a first embodiment of the present invention;

FIG. 2 is a first graphical user interface (GUI), which illustrates means for a user to login to the system shown in FIG. 1;

FIG. 3 is a second GUI, which illustrates means for searching software files that are stored in the system of FIG. 1, and are to be selected for further distribution in accordance with the method of the present invention;

FIG. 4 is a third GUI, which illustrates means for selecting the software files for distribution in accordance with the method of the present invention;

FIG. 5 is a fourth GUI, which illustrates means for displaying the contents of a shopping cart used in accordance with the method of the present invention;

FIG. 6 is a fifth GUI, which illustrates means for confirming those software files selected for distribution in accordance with the method of the present invention;

FIG. 7 is a sixth GUI, which illustrates means for confirming/correcting the shipping address to which the software files selected for distribution shall be shipped in accordance with the method of the present invention;

FIG. 8 is a seventh GUI, which illustrates means for confirming those selected software files ordered in accordance with the method of the present invention; and

FIG. 9 is a more detailed block diagram of the software distribution system according to a second embodiment of the present invention.

### DETAILED DESCRIPTION OF THE INVENTION

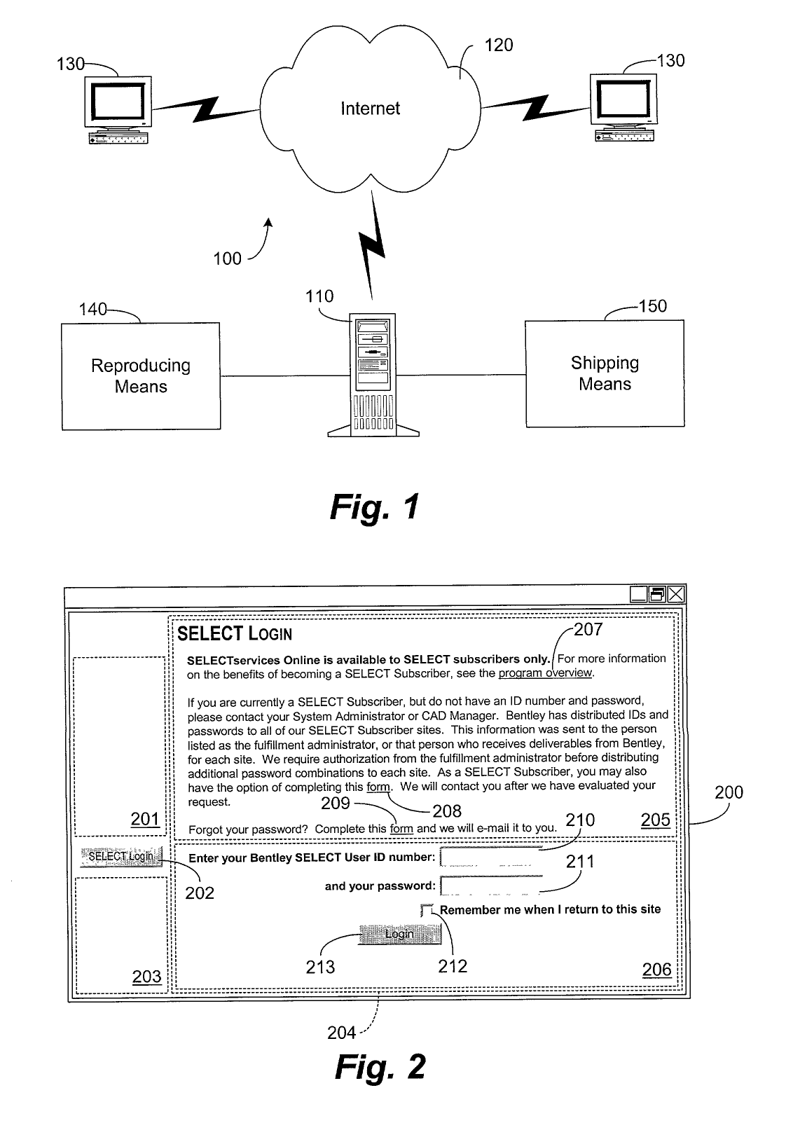

Referring now to the drawings, wherein like reference characters and/or numerals designate like or corresponding parts throughout each of the several views, there is shown in FIG. 1 a simplified block diagram of the software distribution system 100 according to a first embodiment of the present invention. System 100 generally comprises a web server 110, which is effectively coupled to the Internet 120, to permit access to the web server 110 by one or more client devices 130. By use of the term “Internet”, it should be understood that the foregoing is not intended to limit the present invention to a network also known as the World Wide Web. It includes intranets, extranets, Virtual Private Networks (VPNs), and the like.

As is well known, web server 110 comprises a computer that delivers or serves up web pages. Every web server has an IP address and possibly a domain name. For example, if a user at a client device 130 enters the URL <<http://www.bentley.com/index.htm>>, this sends a request to the server whose domain name is “bentley.com”. The server then fetches the web page named “index.htm”, and sends it to the user's browser. Any computer can be turned into a web server by installing server software and connecting the machine to the Internet. For example, there are many web server software applications, including public-domain software from NCSA and Apache, and commercial packages from Microsoft, Netscape, and others. Web server 110 in this first embodiment of the present invention is used to interactively control the search, retrieval, reproduction, and shipping of software files stored in appropriate means within the system 100. For example, such means for storing the software files may be provided by a file server or database server (not shown) coupled to the web server 110, or to mass storage devices within or coupled to the web server 110 (e.g., disk or tape drives).

A first graphical user interface (GUI), illustrating means for a user to login to the system 100 of FIG. 1, is shown in FIG. 2. Such a GUI comprises a web page 200 having one or more sections 201, 202, 203, 204, 205, and 206, each of which may be used to assist a user in navigating system 100. For example, sections 201 and 203 may suitably comprise a “frame” or “link” to other web pages within and without system 100. A frame is a feature supported by most Web browsers that enables the Web author to divide the browser display area into two or more sections. The contents of each frame are taken from a different web page. In hypertext systems, such as the World Wide Web, a link is a reference to another document. Such links are sometimes called hot links because they take a user to other documents when the user clicks on them. As will become more apparent from the following detailed description of the method according to the present invention, section 202 and its counterparts may also be used on web pages other than web page 200 to return the user to that web page 200.

Section 205 suitably comprises means for instructing the user to use and access system 100. If a user is uninitiated in the use of system 100, the user may first access a program overview that is contained on another web page (not shown) which is accessible by clicking link 207. Preferably, a user may access system 100 only after satisfying certain prerequisites (e.g., subscribing to the system 100, obtaining a user ID and password, etc.). In the event that a user is also a subscriber, the user ID and password may be provided through a system administrator, or by submitting a form (not shown) which is accessible by clicking link 208. Moreover, in the event that the user having previously been assigned a user ID and password had forgotten that password, the user may submit another form (not shown) which is accessible by clicking link 209. The user may then conveniently enter the user ID in edit box 210 and password in edit box 211. If the user wishes to have the system 100 remember the user ID and password, a check may be placed in check box 212 by clicking same. Finally, in order to further access system 100 after having entered the user ID and password in edit boxes 210, 211, the user must simply click on login button 213.

A second GUI, illustrating means for searching software files that are stored in the system 100, and are to be selected for further distribution in accordance with the method of the present invention, is shown in FIG. 3. Like the web page 200 shown in FIG. 2, web page 300 comprises one or more sections 301, 302, 303, 304, 305, and 306, each of which may be used to assist a user in navigating system 100. General instructions regarding the use of web page 300 are shown, for example, in section 305. Once ready, the user chooses the files to select from by entry of an appropriate platform, application group, discipline, and language, respectively, from the list boxes 307, 308, 309, and 310. The user may also restrict the selection of files posed within or without a predetermined period of time by clicking an appropriate one of a plurality of radio buttons 311. In addition, the user may sort the files available for selection by clicking either one of a pair of radio buttons 312. If the user makes a mistake or desires to start over, the user may click the “clear” button 313. Otherwise, system 100 may be made to show the available software files by clicking the “show files” button 314.

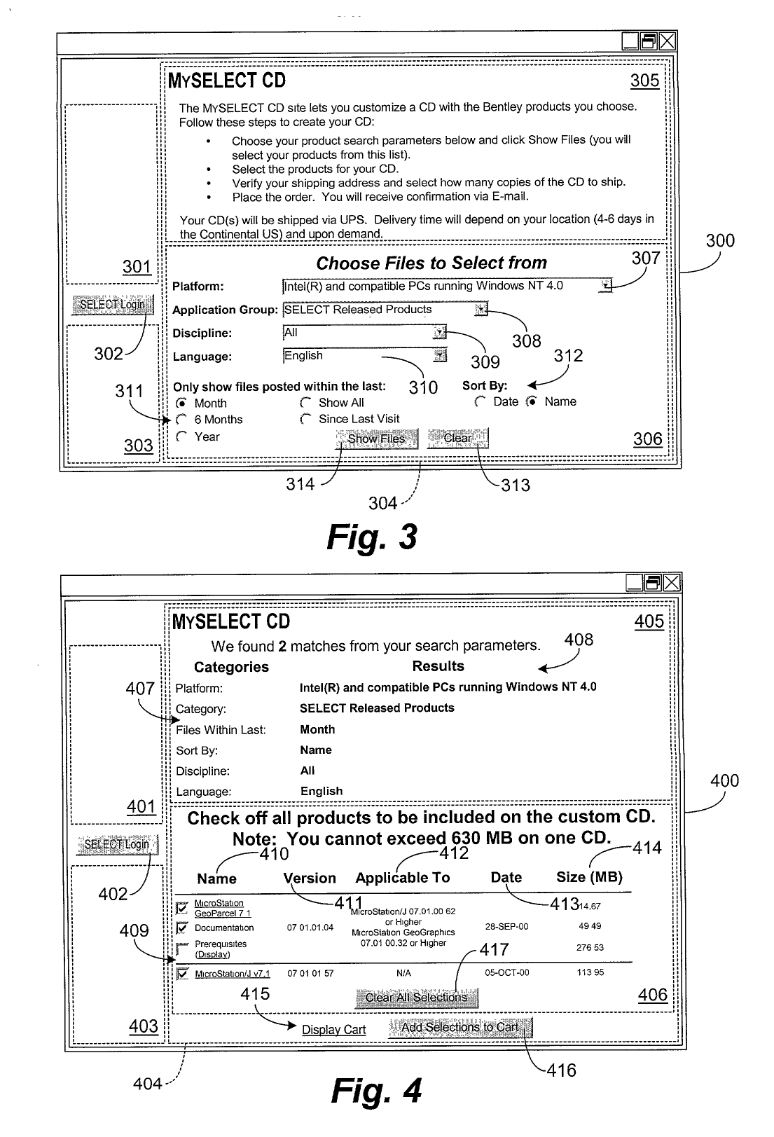

A third GUI, illustrating means for selecting the software files for distribution in accordance with the method of the present invention, is shown in FIG. 4. Web page 400 may be divided into one or more sections 401, 402, 403, 404, 405, and 406, as in the case of web pages 200 and 300. Section 405 indicates generally that two software files matched the queried categories 407 arising from results 408. The user may then refer to section 406 in order to check off those software files to be included in the computer-readable medium to be distributed. For example, a check box 409 will be displayed within section 406 for each name 410 of the software files found by system 100 in reply to the user's query. Check boxes 409 may be defaulted to a checked condition, or to an unchecked condition. However, once the user has reviewed the other columns 411, 412, 413, and 414, and is satisfied with those selections, the user may either click on the “display cart” link 415 to review those software files previously selected, or click on the “add selections to cart” button 416 to do just that. In the event that the user is dissatisfied with the available selections, the user may clear those selections by clicking on the “clear all selections” button 417.

A fourth GUI, illustrating means for displaying the contents of a shopping cart used in accordance with the method of the present invention, is shown in FIG. 5. Like each of the foregoing web pages 200, 300, and 400, web page 500 comprises one or more sections 501, 502, 503, 504, 505, and 506. Section 505 includes a review of the data 507, 508, 509, 510, 511, 512 previously entered on web page 300 (FIG. 3). If the user makes a mistake or desires to start over, the user may click the “clear” button 513. Otherwise, system 100 may be made to show the available software files by clicking the “show files” button 514. In section 506, the user may then review the software files to be reproduced. In the event that the user wishes to remove one of the software files shown in section 506, the user may check the respective check box 515 under the “remove item” column. The user may also move a selected file from one disc to another (if more than one CD is selected) by selecting the respective list box 517 under the “disc number” column. Other information, such as “name” 516, “platform” 518, “version” 519, and “size” 520 of the selected files are shown within section 506. In the event that the user has completed such removals/moves, the user may either update the user's overall selections by clicking on the “update cart” button 521, or reset the web page 500 by clicking on the “reset” button 522. The user may, if satisfied, determine the remaining space available on the CD to be reproduced at edit box 523, and proceed to checkout by clicking the “checkout” button 524 at the bottom of section 504.

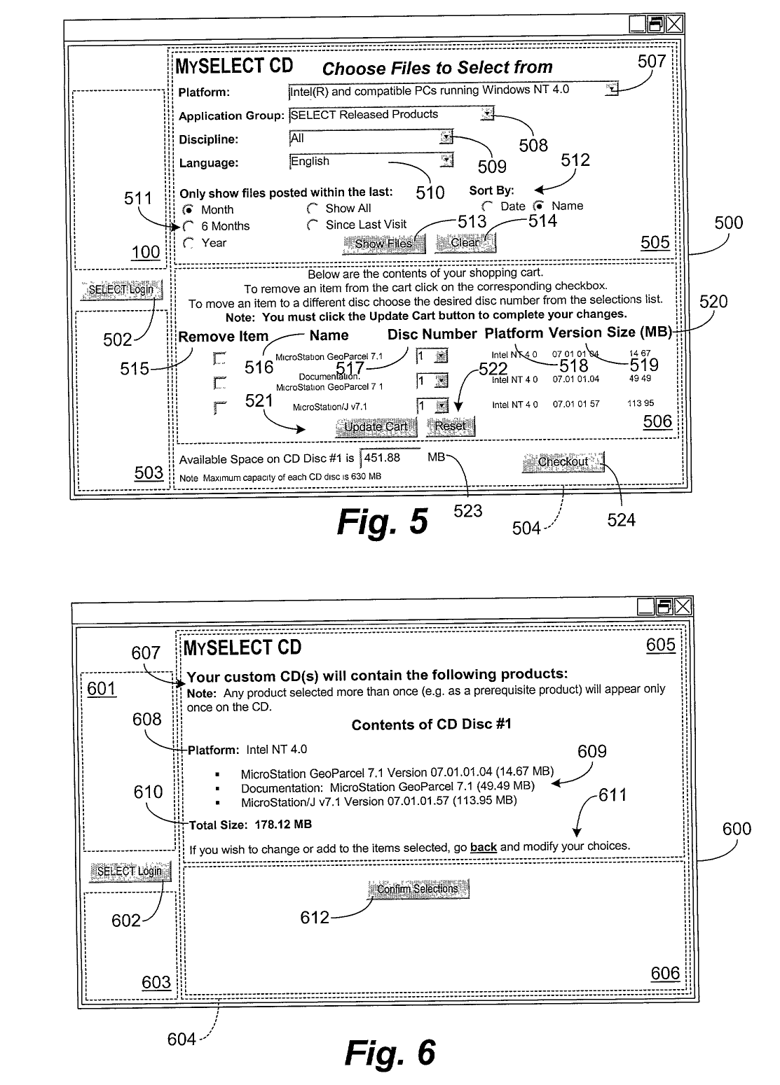

A fifth GUI, illustrating means for confirming those software files selected for distribution in accordance with the method of the present invention, is shown in FIG. 6. Again, as with each of the foregoing web pages 200, 300, 400, and 500, web page 600 comprises one or more sections 601, 602, 603, 604, 605, and 606. Section 605 comprises information 607 relating to the software files to be reproduced, including the contents of each disc in the event one or more computer-readable medium is to be reproduced. For example, information 608 relating to the selected platform, information 609 relating to the software files selected, and information 610 relating to the total size of the software files to be reproduced is made available to the user for confirmation. In the event the user wishes to change or add to the items selected, a link 611 is provided to go back and modify those choices. Once confirmed, however, the user may memorialize such confirmation by clicking on the “confirm selections” button at the bottom of section 606.

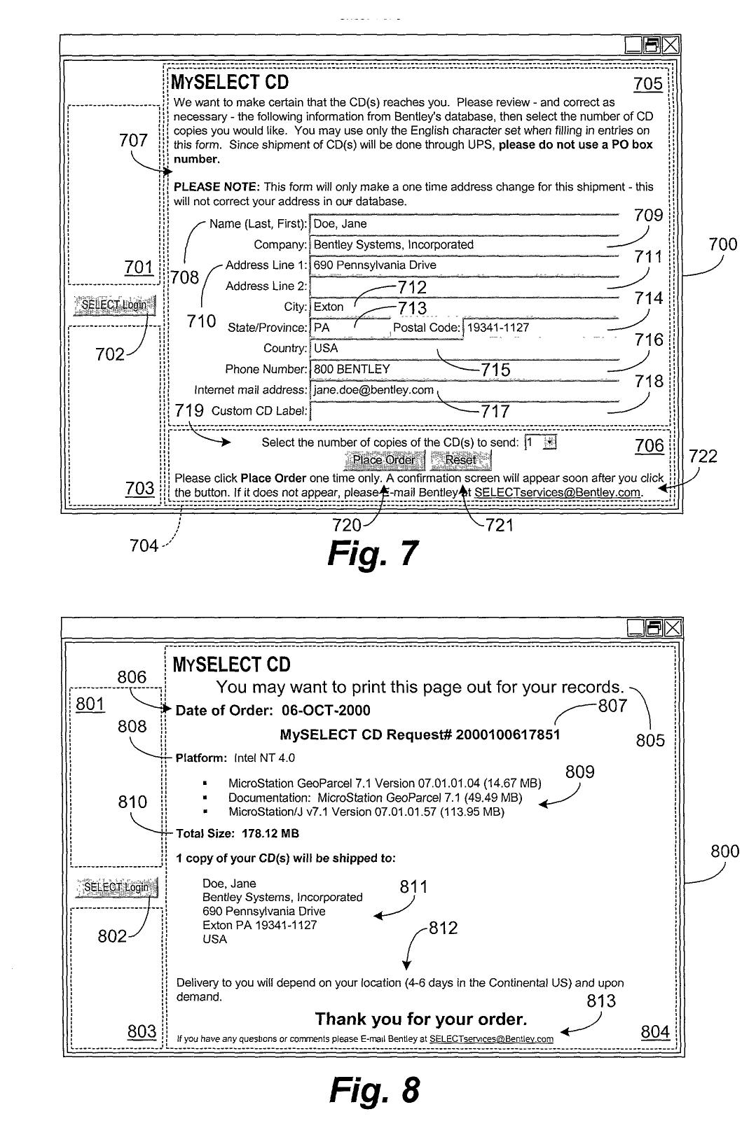

A sixth GUI, illustrating means for confirming/correcting the shipping address to which the software files selected for distribution shall be shipped in accordance with the method of the present invention, is shown in FIG. 7. Web page 700 comprises one or more sections 701, 702, 703, 704, 705, and 706 to assist in the navigation of system 100. Section 706 includes instructions 707 for the user to confirm/correct shipping information relating the user's name 708, company 709, address 710, 711, city 712, state 713, postal code 714, country 715, telephone number 716, Internet mail address 717, and custom CD label 718, if any, as selected by the user. Once of the above-noted shipping information has been confirmed by the user, the user then may select the number of copies of the computer-readable medium to be sent by selecting the appropriate number in list box 719. Thereafter, the user may either place the order by clicking the “place order” button 720, or reset web page 700 by clicking the “reset” button 721 at the bottom of section 706.

A seventh GUI, illustrating means for confirming those selected software files ordered in accordance with the method of the present invention, is shown in FIG. 8. Web page 800 comprises one or more sections 801, 802, 803, and 804. Within section 804, the user is reminded at 805 to print out web page 800 for the user's records. Other information, including the date of the order 806, the request number of the order 807, the platform 808 selected, the software files 809 selected, the total size 810 of the software files selected for reproduction, and the shipping address 811, are also presented to the user for the user's records. An E-mail containing this same information will be sent by the system 100 by the user automatically. Moreover, the user is reminded that the shipment of the computer-readable medium having the selected software files is displayed at 812, and questions or comments are solicited with a link to the appropriate E-mail address at 813.

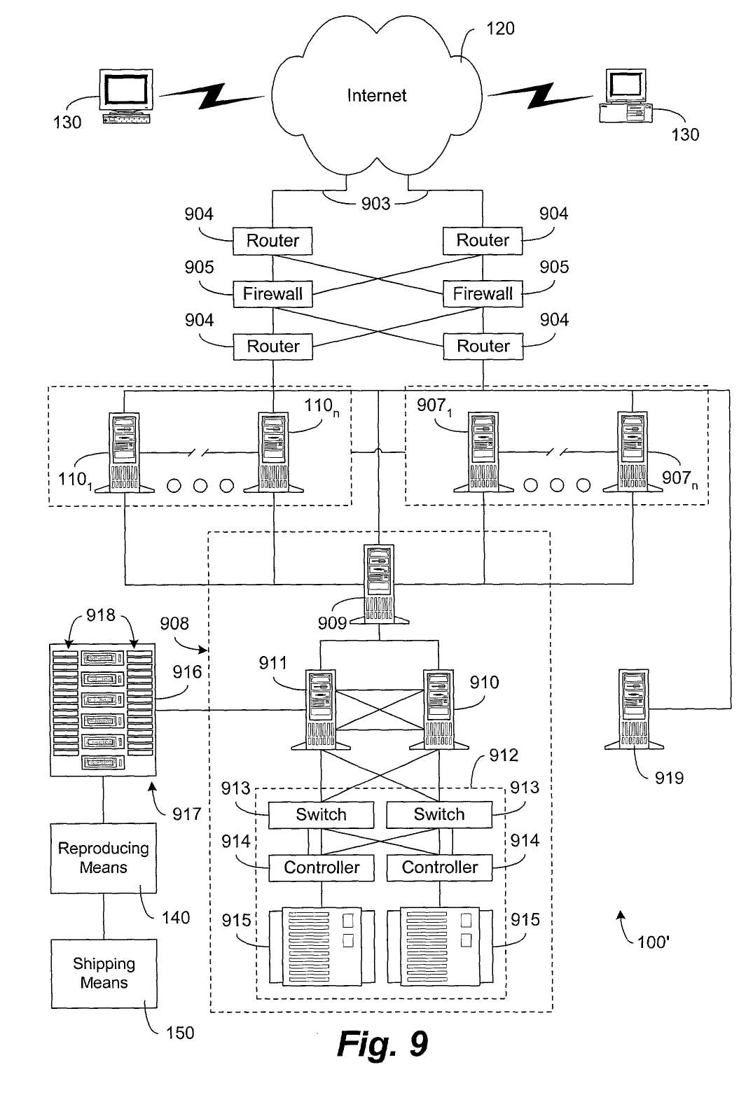

In a second embodiment of the invention, software distribution system 100′ is a software application that may be a part of an Internet service executable on application servers provided in a typical three-tiered architecture. In this architecture, as shown in FIG. 9, the software application is provided via a web site.

System 100′ is adapted to be accessed by a plurality of client devices 130. Such client devices 130, in turn, suitably comprise one or more conventional personal computers and workstations. It should be understood, nevertheless, that other client devices 130 such as Web-enabled hand-held devices (e.g., the Palm V™ organizer manufactured by Palm, Inc., Santa Clara, Calif. U.S.A., Windows CE devices, and “smart” phones) which use the wireless access protocol, and Internet appliances fall within the spirit and scope of the present invention.

Client devices 130 of all of the above types suitably access system 100′ by way of the Internet 120. In any case, a pair of Internet access lines 903 (e.g., primary and shadow conventional T3 lines) are cross connected from the Internet 120 backbone to one or more, and preferably, a pair of redundant routers 904. Incoming traffic from the first of such routers 904 is then suitably directed through a firewall 905 to the second of such routers 904. Even more preferably, and for the sake of redundancy, two firewalls 905 are cross-connected as shown in FIG. 9. A presently preferred router 904 is the SmartSwitch Router 8000, which is manufactured by the Enterasys Networks division of Cabletron Systems, Andover, Mass. U.S.A. Moreover, a presently preferred firewall 905 is an IP network application platform (e.g., the IP650, IP440, or IP330 firewall platforms, which are manufactured by Nokia Group, Espoo, Finland).

A plurality of web servers 110₁ . . . 110ₙ, is, thus, conveniently load balanced by use of the foregoing configuration. That is, the load of incoming traffic from the Internet 120, through the routers 904 and firewalls 905, is balanced among each of the web servers 110₁ . . . 110ₙ, such that: (1) certain incoming traffic is routed to a particular web server 110₁ . . . 110ₙ, where that particular web server 110₁ . . . 110ₙ had been recently used by a given user whose information had been cached on that particular web server 110₁ . . . 110ₙ and, as a result, it would be more efficient to continue to use that particular web server 110₁ . . . 110ₙ; or (2) no single one of the web servers 110₁ . . . 110ₙ would become overburdened.

In a preferred embodiment of the present invention, there are three such web servers. Each of the web servers 110₁ . . . 110ₙ is, in turn, preferably comprised of a Dell™ PowerEdge™ 2450 server (manufactured by Dell Computer Corporation, Austin, Tex. U.S.A.), with a 733 MHz Pentium III processor, 256 MB RAM, and dual, mirrored 9.1 GB fixed disk drives. Preferably, each of the web servers 110₁ . . . 110ₙ further comprises a Microsoft® Windows® NT operating system, and Netscape Enterprise Server, Release 3.6.3 (developed by Netscape Communications Corporation, a subsidiary of America Online, Inc., Dulles, Va. U.S.A.). Optionally, Netscape's Certificate Server may also be installed on each of the web servers 110₁ . . . 110ₙ to facilitate core digital certificate-issuance and management services, as well as distribution of certificates and certificate-revocation lists to clients and other servers. Other forms of certificate servers (e.g., web certificate servers and wireless certificate servers, which are available from VeriSign, Inc., Mountain View, Calif. U.S.A.) may likewise be deployed on each of the web servers 110₁ . . . 110ₙ.

System 100′ further comprises a plurality of application servers 907₁ . . . 907ₙ, coupled to the web servers 110₁ . . . 110ₙ. In the preferred embodiment of the present invention, there are six such application servers. Each of the application servers 907₁ . . . 907ₙ is, like the web servers 110₁ . . . 110ₙ, preferably comprised of a Dell PowerEdge 2450 server, with a 733 MHz Pentium III processor, 256 MB RAM, and dual, mirrored 9.1 GB fixed disk drives. Preferably, each of the application servers 907₁ . . . 907ₙ further comprises a Microsoft Windows NT operating system, and the Total-e-Business™ platform, developed by Bluestone Software, Inc., Philadelphia, Pa. U.S.A., and including the Total-e-Business Server (formerly known as “Sapphire/Web”). Bluestone's Universal Business™ Server, Release 7.0, for example, may be used to manage the software distribution system and methods of the present invention, while running on each of the application servers 907₁ . . . 907ₙ. At the same time, Bluestone's Load Balance Broker (LBB) is loaded on each of the web servers 110₁ . . . 110ₙ, to facilitate balancing of the load of communications between each of the web servers 110₁ . . . 110ₙ and each of the application servers 907₁ . . . 907ₙ.

Beneath the layer of web servers 110₁ . . . 110ₙ and application servers 907₁ . . . 907ₙ is a storage area network (SAN) 908. SAN 908 generally comprises a cluster server 909 that is connected to receive incoming Internet traffic through each of the application servers 907₁ . . . 907ₙ, and to transmit outgoing Internet traffic through the routers 904 and firewall 905, from the SAN 908 by way of either a file server 910 or a database server 911.

As seen in FIG. 9, the hardware comprising system 100′ is substantially completed with the addition of high-availability storage 912 cross-connected to the file server 910 and database server 911. One suitable such high-availability storage 912 comprises the fibre channel switches 913, a pair of disk controllers 914, and a pair of disk arrays 915. Each of the disk controllers 914 preferably comprises a SCSI controller (e.g., a Symbios® SYM53C1010 Ultra160 SCSI controller, manufactured by LSI Logic Corporation, Milpitas, Calif. U.S.A.). In a presently preferred embodiment, the disk arrays 915 each comprise twenty 36 GB LVD (i.e., low voltage differential) disk drives which are configured to be mirrored RAID 5. Suitable such LVD drives are, for example, the Ultrastar 36ZX hard disk drives manufactured by IBM Corporation, Armonk, N.Y. U.S.A.

System 100′ further comprises a tape library 916, which includes a plurality of advanced intelligent tape drives 917 (preferably AIT2 tape drives) and a plurality storage positions 918 for the AIT2 tapes. In a presently preferred embodiment, the tape library 916 comprises a TLS-4000 automated tape library (manufactured by Qualstar Corporation, Canoga Park, Calif. U.S.A.), which can incorporate up to 12 AIT2 tape drives and has storage for at least 60 AIT2 tapes. Such tape library 916 furthermore preferably comprises suitable software (e.g., Veritas Netbackup™) to control reading and writing of data to the tape library 916.

A software process that takes receipt of HTTP requests preferably runs on web servers 110₁ . . . 110ₙ. The web servers 110₁ . . . 110ₙ either handle the requests or forward them to other software/systems for handling. The software application preferably runs on the application servers 907₁ . . . 907ₙ behind the web servers. The web servers forward appropriate requests to the application servers for processing. Responses to such requests are generated by the application servers and are passed back through the web server to the requesting client. However, the general manner in which this process occurs is well-known to those skilled in the art, and will not be described in more detail here.

Whether in the system 100 according to FIG. 1 or the system 100′ according to FIG. 9, the method according to the present invention utilizes reproducing means 140 and shipping means to expedite the delivery of the computer readable media remotely selected by an authorized subscriber thereof. In a presently preferring embodiment of the invention, reproducing means 140 suitably comprises a cdDIRECTOR™ or cdDIRECTOR2000™ disc-on-demand CD replicator manufactured by MediaFORM of Exton, Pa. U.S.A. Connected to system 100 or system 100′, either reproducing means integrates seamlessly with such system 100 or system 100′, effectively becoming a CD print server. With up to six 8X CD-R drives, 200 disc input, inline printing, and multiple SCSI hard drives all running in a true preemptive multitasking environment, the cdDIRECTOR™ or cdDIRECTOR2000™ replicators provide reliable reproduction of the software files selected by the user.

Jobs are created through a single application where each element of a job is logically separated through the use of Windows® (a registered trademark of Microsoft Corporation of Redmond, Wash., U.S.A.) tabs. One tab facilitates creation of a CD's custom artwork. Integrated printing labels the discs in-line to the disc recording process making identification easy. In this case, system 100 or system 100′ interfaces with such reproducing means 140 to gather the customer information, comment, serial number, and copy number (FIG. 8), bar codes that serial number, and sends a label file to the reproducing means 140 to print such information on the CD at the same time that the selected software files are reproduced. At this point, as noted herein above, an E-mail is sent to the user and the software provider/operator of system 100 or system 100′, informing them that the CD has been sent, where it has been sent, and its contents.

The completed CD is then forwarded to shipping with a package suitable for courier delivery (e.g., a United Parcel Service or UPS-approved CD package). Shipping means 150 includes software, which is suitable for interfacing with such courier delivery service and capable of reading the bar code printed on the CD having the selected software files reproduced thereon. Scan of the bar code by shipping means 140 triggers the customer information to format in the manner suitable for labels used by the courier delivery service. Shipping means 140 then prints out a label, the CD is inserted in the package, and the label attached thereto. System 100 or system 100′ thereafter retains information related to each CD made in order to customize service reports for use by the software provider or the user.

The embodiments illustrated and discussed in this specification are intended only to teach those skilled in the art the best way presently known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. For example, the web browser may be any content display device capable of linking and any other language that can support link can be used in place of HTML. Moreover, additional ways for processing the shipping means will be apparent to those skilled in the art. Once presently preferred software application for implementing the shipping means is the HARVEY system, developed by Harvey Software, Inc. Further information regarding the operation and use of an especially preferred embodiment of the present invention may be found at <<http://selectservices.bentley.com>> and web pages subservient thereto, each of which is incorporated herein by reference. It is therefore to be understood that, within the scope of the claims and their equivalents, the invention may be practiced otherwise than as specifically described herein.

What is claimed as our invention is:

1. A system for selectively reproducing software files remotely from a provider of the software files, comprising:
a web server;
a database coupled to said web server and containing a plurality of software files;
browser-enabled means for coupling one or more client devices to said web server, wherein said client devices have installed therein one or more applications corresponding to said plurality of software files contained in said database;
means for reproducing selected ones of said plurality of software files selected by a user accessing said web server from one of said one or more client devices, said selected ones of said plurality of software files being reproduced on a computer readable medium; and
means for shipping said computer readable medium to said user with data recorded thereon indicative of said user and said selected ones of said plurality of software files.

2. The system according to claim 1, wherein said browser-enabled means for coupling said one or more client devices to said web server further comprises a graphical user interface including information related to instructions for use of the system, first means for entering a user ID number, second means for entering a password, said user ID number and said password having been previously associated with said user, and means for logging into the system by entry of said user ID number and said password.

3. The system according to claim 1, wherein said browser-enabled means for coupling said one or more client devices to said web server further comprises a graphical user interface including information related to instructions for search of said database, first means for entering a preferred platform for use of said plurality of software files, second means for entering a predetermined group of said plurality of software files, third means for entering a predetermined discipline; fourth means for entering a preferred language of said plurality of software files and documentation related thereto, fifth means for entering a selected period of time in which said plurality of software files had been posted to said database, sixth means for entering a desired sort of said plurality of software files by date or by name, and seventh means for entering to said database information indicative of that entered by said first, second, third, fourth, fifth, and sixth entering means.

4. The system according to claim 1, wherein said browser-enabled means for coupling said one or more client devices to said web server further comprises:
a graphical user interface, which is adapted to display said information indicative of that entered by said first, second, third, fourth, fifth, and sixth entering means; and
means, which is adapted to display results of a search of said database by said user and thereby facilitate selection of one or more of said plurality of software files.

5. The system according to claim 4, wherein said selection means further comprises:
a user-enabled check box associated with each of said plurality of software files displayed as a result of said search;
means for clearing user selections;
means for adding user selections to a shopping cart paradigm; and
means for displaying a content of said shopping cart.

6. The system according to claim 1, wherein said browser-enabled means for coupling said one or more client devices to said web server further comprises:
a graphical user interface, which is adapted to display said information indicative of that entered by said first, second, third, fourth, fifth, and sixth entering means;
shopping cart means, which is adapted to display results of a search of said database by said user and thereby facilitate selection and removal of one or more of said plurality of software files;
means for entering a command to the system to update a content of said shopping cart means;
means for resetting said graphical user interface; and
user-enabled means for entering a command to checkout.

7. The system according to claim 6, further comprising means for indicating an amount of reproducible space remaining on said computer readable medium.

8. The system according to claim 6, wherein said browser-enabled means for coupling said one or more client devices to said web server further comprises another graphical user interface, which is adapted to display information indicative of said content of said shopping cart means, and means for confirming a user's selections based on said information displayed in said other graphical user interface.

9. The system according to claim 1, wherein said browser-enabled means for coupling said one or more client devices to said web server further comprises:
a graphical user interface, which is adapted to display information indicative of a shipping address for said user;
means for changing said information indicative of said shipping address; and
user-enabled means for entering a command to place an order using said information indicative of said shipping address.

10. The system according to claim 1, wherein said browser-enabled means for coupling said one or more client devices to said web server further comprises a graphical user interface, which is adapted to display information indicative of a date of an order by said user, a request number correlated to said selected plurality of software files, and a shipping address for said user.

11. The system according to claim 1, wherein said computer readable medium comprises a CD.

12. The system according to claim 11, wherein said reproducing means further comprises means for printing indicia on said CD that is capable of identifying said user and said selected plurality of software files reproduced thereon.

13. The system according to claim 12, wherein said shipping means further comprises means for reading said indicia and for printing a shipping label including information indicative of a shipping address for said user.

14. A system for selectively reproducing software files remotely from a provider of the software files, comprising:
a web server;
a database coupled to said web server and containing a plurality of software files;
browser-enabled means for coupling one or more client devices to said web server, wherein said client devices have installed therein one or more applications corresponding to said plurality of software files contained in said database, said browser-enabled means including:
a first graphical user interface including information related to instructions for use of the system, first means for entering a user ID number, second means for entering a password, said user ID number and said password having been previously associated with said user, and means for logging into the system by entry of said user ID number and said password;
a second graphical user interface including information related to instructions for search of said database, first means for entering a preferred platform for use of said plurality of software files, second means for entering a predetermined group of said plurality of software files, third means for entering a predetermined discipline; fourth means for entering a preferred language of said plurality of software files and documentation related thereto, fifth means for entering a selected period of time in which said plurality of software files had been posted to said database, sixth means for entering a desired sort of said plurality of software files by date or by name, and seventh means for entering to said database information indicative of that entered by said first, second, third, fourth, fifth, and sixth entering means;
a third graphical user interface, which is adapted to display said information indicative of that entered by said first, second, third, fourth, fifth, and sixth entering means;
a fourth graphical user interface, which is adapted to display results of a search of said database by said user and thereby facilitate selection of one or more of said plurality of software files;
a fifth graphical user interface, which is adapted to display said information indicative of that entered by said first, second, third, fourth, fifth, and sixth entering means, said fifth graphical interface means including shopping cart means, which is adapted to display results of a search of said database by said user and thereby facilitate selection and removal of one or more of said plurality of software files, means for entering a command to the system to update a content of said shopping cart means, means for resetting said graphical user interface, and user-enabled means for entering a command to checkout;
a sixth graphical user interface, which is adapted to display information indicative of said content of said shopping cart means, and means for confirming a user's selections based on said information displayed in said other graphical user interface;
a seventh graphical user interface, which is adapted to display information indicative of a shipping address for said user, means for changing said information indicative of said shipping address, and user-enabled means for entering a command to place an order using said information indicative of said shipping address;
an eighth graphical user interface, which is adapted to display information indicative of a date of an order by said user, a request number correlated to said selected plurality of software files, and a shipping address for said user;
means for reproducing selected ones of said plurality of software files selected by a user accessing said web server from one of said one or more client devices, said selected ones of said plurality of software files being reproduced on a computer readable medium; and
means for shipping said computer readable medium to said user with data recorded thereon indicative of said user and said selected ones of said plurality of software files.
